(19) United States
(12) Patent Application Publication
(10) Pub. No.: US 2022/0254185 A1
(43) Pub. Date: Aug. 11, 2022

(54) FINGERPRINT SENSING DEVICE AND OPERATION METHOD THEREOF

(71) Applicant: Egis Technology Inc., Hsinchu City (TW)

(72) Inventors: Bruce C. S. Chou, Hsinchu City (TW); Tong-Long Fu, Hsinchu City (TW)

(73) Assignee: Egis Technology Inc., Hsinchu City (TW)

(21) Appl. No.: 17/580,606

(22) Filed: Jan. 20, 2022

Related U.S. Application Data
(60) Provisional application No. 63/147,184, filed on Feb. 8, 2021.

(30) Foreign Application Priority Data
Nov. 30, 2021 (CN) 202111441659.7

(51) Int. Cl. G06V 40/13

(52) U.S. Cl. CPC G06V 40/1318

(57) ABSTRACT

A fingerprint sensing device and an operation method thereof are provided. The fingerprint sensing device includes a sensing pixel array and a processing circuit. The sensing pixel array senses a finger during a fingerprint sensing period to obtain a fingerprint sensing signal. At least one pixel area of the sensing pixel array further continuously senses the finger during the fingerprint sensing period to obtain a physiological characteristic signal. The processing circuit is coupled to the sensing pixel array. The processing circuit generates a fingerprint image according to the fingerprint sensing signal, and generates physiological characteristic information according to the physiological characteristic signal.

### CROSS-REFERENCE TO RELATED APPLICATION

This application claims the priority benefit of U.S. Provisional Application No. 63/147,184, filed on Feb. 8, 2021 and China Application No. 202111441659.7, filed on Nov. 30, 2021. The entirety of each of the above-mentioned patent applications is hereby incorporated by reference herein and made a part of this specification.

### BACKGROUND

### Technical Field

The disclosure relates to a sensing technology, and particularly relates to a fingerprint sensing device and an operation method thereof.

### Description of Related Art

Generally, the conventional means of sensing physiological characteristic information of a finger is to illuminate the finger through a green or infrared light source, and then capture changes in intensity of light continuously reflected by the finger by a light sensor. The physiological characteristic information may be obtained from the changes in intensity of light continuously reflected by the finger after image analysis. However, if an electronic device with a fingerprint sensing function needs to have a physiological characteristic sensing function at the same time, a light source and an image sensor need to be additionally disposed on the electronic device. Therefore, the cost and volume of the device will be increased, causing the practicality of the electronic device to be poor.

### SUMMARY

The disclosure provides a fingerprint sensing device and an operation method thereof, which can provide a fingerprint sensing function and a physiological characteristic sensing function.

A fingerprint sensing device of the disclosure includes a sensing pixel array and a processing circuit. The sensing pixel array is configured to sense a finger during a fingerprint sensing period to obtain a fingerprint sensing signal. At least one pixel area of the sensing pixel array is further configured to continuously sense the finger during the fingerprint sensing period to obtain a physiological characteristic signal. The processing circuit is coupled to the sensing pixel array. The processing circuit is configured to generate a fingerprint image according to the fingerprint sensing signal and generate physiological characteristic information according to the physiological characteristic signal.

An operation method of a fingerprint sensing device of the disclosure includes the following steps. A finger is sensed through a sensing pixel array during a fingerprint sensing period to obtain a fingerprint sensing signal. A fingerprint image is generated according to the fingerprint sensing signal. The finger is continuously sensed through at least one pixel area of the sensing pixel array during the fingerprint sensing period to obtain a physiological characteristic signal. Physiological characteristic information is generated according to the physiological characteristic signal.

Based on the above, in the fingerprint sensing device and the operation method of the disclosure, the finger may be sensed through the sensing pixel array during the fingerprint sensing period to obtain the fingerprint sensing signal, and the finger may be sensed through the pixel area of a part of the sensing pixel array to obtain the physiological characteristic signal. Therefore, in the fingerprint sensing device and operation method of the disclosure, the fingerprint image and the physiological characteristic information corresponding to the same finger may be generated during the fingerprint sensing period.

In order for the features and advantages of the disclosure to be more comprehensible, the following specific embodiments are described in detail in conjunction with the accompanying drawings.

### BRIEF DESCRIPTION OF THE DRAWINGS

FIG. 1 is a schematic diagram of a fingerprint sensing device according to an embodiment of the disclosure.

FIG. 2 is a schematic diagram of a sensing pixel array according to an embodiment of the disclosure.

FIG. 3 is a schematic diagram of an under-screen fingerprint sensing architecture according to an embodiment of the disclosure.

FIG. 4 is a flowchart of an operation method of a fingerprint sensing device according to an embodiment of the disclosure.

FIG. 5 is a schematic diagram of a fingerprint image according to an embodiment of the disclosure.

FIG. 6 is a schematic diagram of a fingerprint image according to another embodiment of the disclosure.

FIG. 7 is a schematic diagram of a sensing circuit according to an embodiment of the disclosure.

FIG. 8 is a schematic diagram of a sensing circuit according to another embodiment of the disclosure.

FIG. 9 is a signal waveform diagram of a physiological characteristic signal according to an embodiment of the disclosure.

FIG. 10 is a schematic diagram of a frequency domain of a physiological characteristic signal according to an embodiment of the disclosure.

FIG. 11 is a signal waveform diagram of a physiological characteristic signal according to another embodiment of the disclosure.

FIG. 12 is a signal waveform diagram of the physiological characteristic signal according to the embodiment of FIG. 11 of the disclosure after correction.

### DETAILED DESCRIPTION OF DISCLOSED EMBODIMENTS

In order for the content of the disclosure to be more comprehensible, the following embodiments are specifically cited as examples on which the disclosure can indeed be implemented. In addition, wherever possible, elements/components/steps with the same reference numerals in the drawings and embodiments represent the same or similar parts.

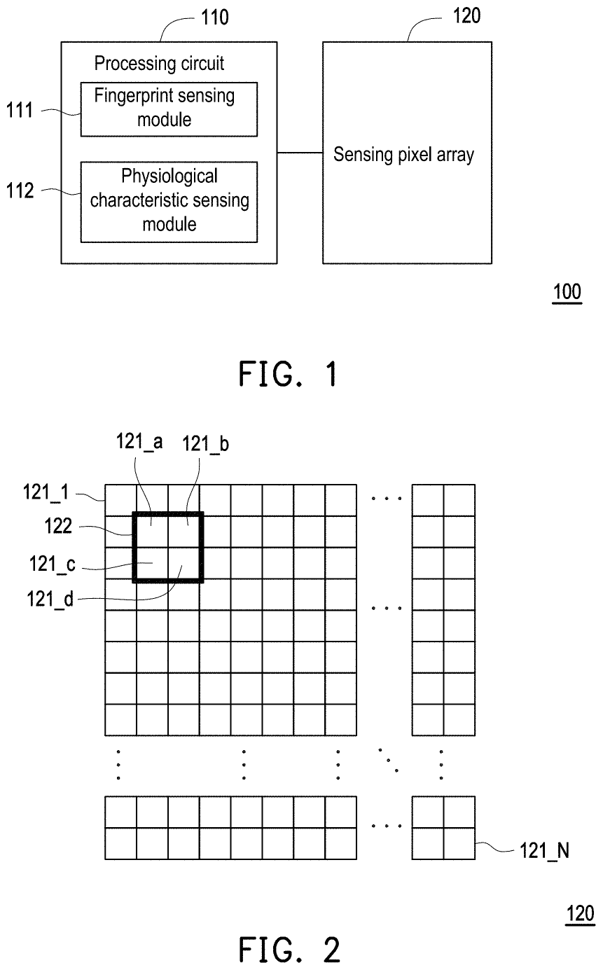

FIG. 1 is a schematic diagram of a fingerprint sensing device according to an embodiment of the disclosure. Referring to FIG. 1, a fingerprint sensing device 100 includes a processing circuit 110 and a sensing pixel array 120. The processing circuit 110 includes a fingerprint sensing module 111 and a physiological characteristic sensing module 112. The processing circuit 110 is coupled to the sensing pixel array 120. In the embodiment, the fingerprint sensing device 100 may be an optical fingerprint sensor and may have a single-chip architecture. The processing circuit 110 and the sensing pixel array 120 may be integrated in the same module, and the fingerprint sensing device 100 may be, for example, disposed under a display screen of an electronic device. However, the implementation of the fingerprint sensing device of the disclosure is not limited thereto.

In the embodiment, the processing circuit 110 may be designed through a hardware description language (HDL) or any other digital circuit design means known to persons skilled in the art, and related hardware circuits may be implemented through means such as a field programmable gate array (FPGA), a complex programmable logic device (CPLD), or an application-specific integrated circuit (ASIC). The processing circuit 110 may include a storage unit, such as a memory. The processing circuit 110 may have a processor with computing capability and driving capability to drive the sensing pixel array 120 to perform a sensing operation, and functions of the fingerprint sensing module 111 and the physiological characteristics sensing module 112 may be implement through executing related algorithms or firmware programs. In an embodiment, the fingerprint sensing module 111 and the physiological characteristic sensing module 112 may also be respectively implemented by separate and different computing circuit.

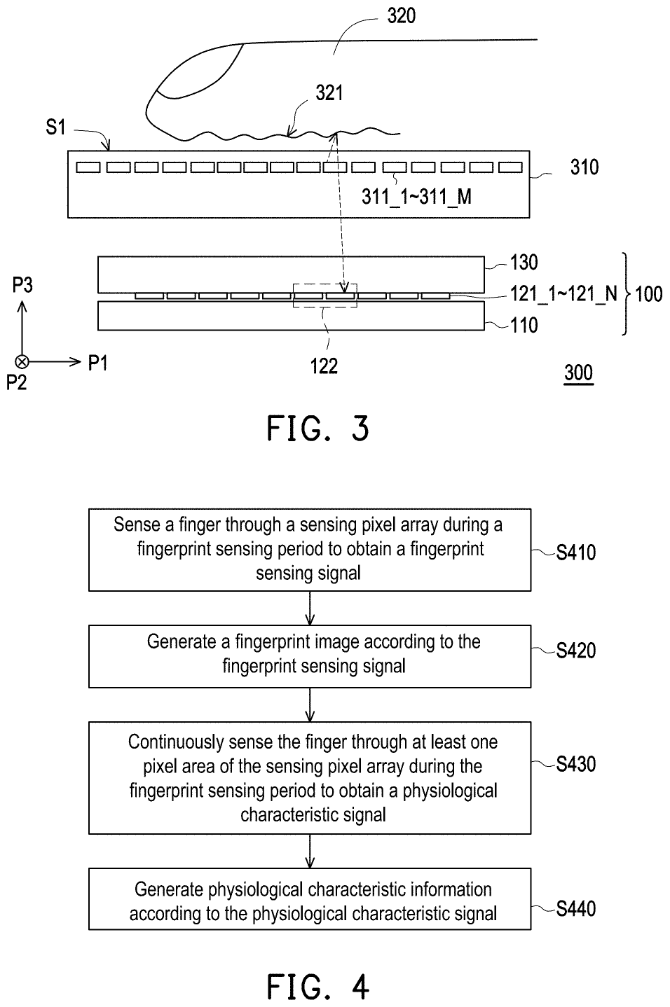

FIG. 2 is a schematic diagram of a sensing pixel array according to an embodiment of the disclosure. FIG. 3 is a schematic diagram of an under-screen fingerprint sensing architecture according to an embodiment of the disclosure. Referring to FIG. 1 and FIG. 2, the sensing pixel array 120 of the embodiment may include multiple sensing pixels 121_1 to 121_N arranged in an array, where N is a positive integer. Referring to FIG. 1 to FIG. 3, in the embodiment, an electronic device 300 may be, for example, a device such as a smart phone or a tablet computer, which is not limited in the disclosure. In the embodiment, a display panel 310 may be, for example, an organic light-emitting diode (OLED) display panel, and the display panel 310 may include multiple light-emitting units 311_1 to 311_M arranged in an array, where M is positive Integer. In other words, during a fingerprint sensing period, a finger 320 placed or pressing on the display panel 310 may be illuminated by the organic light-emitting diode display panel as an illuminating light source.

In the embodiment, a surface S1 of the display panel 310 may be parallel to a plane formed by respectively extending toward a direction P1 and a direction P2, and the surface S1 faces a direction P3, wherein the directions P1 to P3 are perpendicular to one another. In the embodiment, the fingerprint sensing device 100 may further include a light path guiding structure 130. The processing circuit 110 and the sensing pixel array 120 may be disposed under the light path guiding structure 130, and the fingerprint sensing device 100 may be disposed under the display panel 310 of the electronic device 300 to form an under-screen optical fingerprint sensing architecture. In the embodiment, the sensing pixel array 120 may further include at least one lens or collimator, but the disclosure is not limited thereto.

During a display process, the display panel 310 may emit display light toward the direction P3 through the light-emitting units 311_1 to 311_M to display an image. In addition, during a fingerprint sensing period, the display panel 310 may be illuminated through at least a part of the light-emitting units 311_1 to 311_M to emit an illuminating light toward the direction P3 to illuminate a fingerprint surface 321 of the finger 320 placed on the surface S1 of the display panel 310. In addition, after being reflected by the fingerprint surface 321 of the finger 320, reflected light may be incident on the sensing pixel array 120 through the display panel 310 and the light path guiding structure 130. Therefore, the sensing pixels 121_1 to 121_N may receive the reflected light with fingerprint pattern characteristics reflected by the fingerprint surface 321 of the finger 320.

FIG. 4 is a flowchart of an operation method of a fingerprint sensing device according to an embodiment of the disclosure. Referring to FIG. 1 to FIG. 4, the fingerprint sensing device 100 may execute Steps S410 to S440 below to implement a fingerprint sensing operation and a physiological characteristic sensing operation. During the fingerprint sensing period, the display panel 310 may illuminate at least a part of the light-emitting units 311_1 to 311_M corresponding to the sensing pixel array 120 (for example, multiple light-emitting units directly below the finger 320) to emit the illuminating light toward the direction P3 to illuminate the finger 320 placed or pressing on the surface S1 of the display panel 310. The sensing pixels 121_1 to 121_N may receive the reflected light with fingerprint pattern characteristics reflected by the fingerprint surface 321 of the finger 320. Therefore, in Step S410, the fingerprint sensing device 100 may sense the finger 320 through the sensing pixel array 120 during the fingerprint sensing period to obtain the fingerprint sensing signal. The sensing pixel array 120 outputs the fingerprint sensing signal to the processing circuit 110. It is worth noting that the fingerprint sensing device 100 of the embodiment may perform the fingerprint sensing operation through a part of the sensing pixels 121_1 to 121_N, wherein a part of the sensing pixels 121_1 to 121_N refers to other sensing pixels outside a pixel area 122 of the sensing pixel array 120. In Step S420, the fingerprint sensing module 111 of the processing circuit 110 may generate a fingerprint image according to the fingerprint sensing signal.

In Step S430, the fingerprint sensing device 100 may continuously sense the finger 320 through at least one pixel area of the sensing pixel array 120 during the fingerprint sensing period to obtain the physiological characteristic signal, and the sensing pixel array 120 outputs the physiological characteristic signal to the processing circuit 110. It is worth noting that the fingerprint sensing device 100 of the embodiment may continuously sense the physiological characteristic signal of the finger through, for example, sensing pixels 121_a, 121_b, 121_c, and 121_d of the pixel area 122 of a part of the sensing pixel array 120 shown in FIG. 2, where a, b, c, and d are between 1 and N. As such, a sampling frequency of image capturing of the sensing pixels 121_a, 121_b, 121_c, and 121_d of the pixel area 122 of the sensing pixel array 120 may be higher than other sensing pixels. For example, the optimal value of the sampling frequency is between 4 Hz and 1 kHz to effectively detect a heart rate. However, the sampling frequency of the disclosure is not limited to the above example. In other embodiments of the disclosure, the sampling frequency may also be greater than 1 kHz or less than 4 Hz. Therefore, the sensing pixels 121_a, 121_b, 121_c, and 121_d may continuously sample multiple times within a few seconds to continuously output an analog to digital converter code (ADC code). In Step S440, the physiological characteristic sensing module 112 of the processing circuit 110 may generate physiological characteristic information according to the physiological characteristic signal.

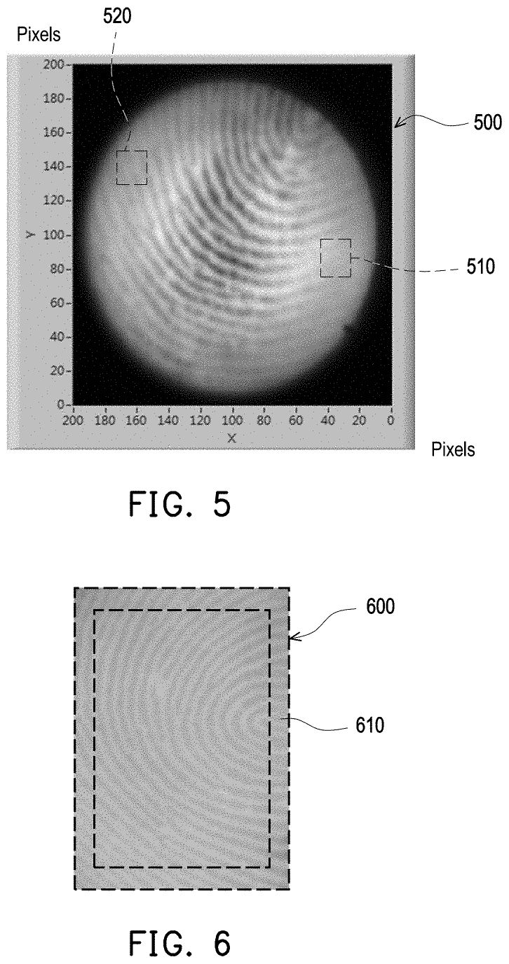

It is further explained that the pixel area configured to sense the physiological characteristic information in the embodiment is not limited to the area position, the area shape, and the number of sensing pixels of the pixel area 122 shown in FIG. 2. During the fingerprint sensing period, the fingerprint sensing device 100 may use the sensing pixel array 120 to obtain the fingerprint image of the finger 320, while using one or more pixel areas of the sensing pixel array 120 corresponding to one or more blurred areas (fingerprint invalid areas) or edge areas of the fingerprint image to sense the physiological characteristic information of the finger 320. As such, the processing circuit 110 may analyze the fingerprint image to judge one or more blurred areas in the fingerprint image, and the processing circuit 110 decides to set a part in the sensing pixel array 120 corresponding to the one or more blurred areas to one or more pixel areas for sensing the physiological characteristic information of the finger 320. Moreover, a total area of the one or more pixel areas of the sensing pixel array 120 is less than an overall sensing area of the sensing pixel array 120. For example, please refer to FIG. 5, which is a schematic diagram of a fingerprint image according to an embodiment of the disclosure. For example, as shown in FIG. 5, in relatively blurred areas of the fingerprint image corresponding to positions of a partial area 510 and a partial area 520 in a fingerprint image 500, the fingerprint sensing device 100 may use a part of two corresponding pixel areas of the sensing pixel array 120 to sense the physiological characteristic information of the finger 320. Alternatively, please refer to FIG. 6, which is a schematic diagram of a fingerprint image according to another embodiment of the disclosure. For example, as shown in FIG. 6, at a position corresponding to an image edge area 610 in a fingerprint image 600, the fingerprint sensing device 100 may use a part of corresponding annular pixel areas of the sensing pixel array 120 to sense the physiological characteristic information of the finger 320.

Therefore, the fingerprint sensing device 100 of the embodiment may obtain the fingerprint image corresponding to the fingerprint surface 321 of the finger 320 and the physiological characteristic information corresponding to the finger 320 at the same time. Moreover, since the fingerprint sensing device 100 of the embodiment uses one or more pixel areas of the sensing pixel array 120 corresponding to one or more fingerprint blurred areas or edge areas in the fingerprint image to sense the physiological characteristic information of the finger 320, the physiological characteristic sensing operation of the embodiment does not affect the fingerprint image obtained by the sensing pixel array 120 for a result of subsequent fingerprint analysis or fingerprint recognition, so that the fingerprint sensing device 100 may obtain the fingerprint image and the physiological characteristic information at the same time during one fingerprint sensing period.

In addition, in the embodiment, the one or more pixel areas of the sensing pixel array 120 may be fixedly disposed for obtaining the physiological characteristic signal, but the disclosure is not limited thereto. In an embodiment, the pixel area for obtaining the physiological characteristic signal may be judged and decided by the processing circuit 110 in real time during each fingerprint image sensing process. For example, the processing circuit 110 may analyze the fingerprint image to judge that there is at least one area in the fingerprint image where a fingerprint signal intensity is lower than a signal intensity threshold to decide to set a part in the sensing pixel array 120 corresponding to the at least one area as the pixel area for obtaining the physiological characteristic signal of the finger 320. Alternatively, in another embodiment, the processing circuit 110 may analyze the fingerprint image to judge that there is at least one area in the fingerprint image where a fingerprint characteristic is less than a characteristic number threshold to decide to set a part in the sensing pixel array 120 corresponding to the at least one area as the pixel area for obtaining the physiological characteristic signal of the finger 320.

In addition, the physiological characteristic information described in each embodiment of the disclosure may, for example, include at least one of a heart rate, a respiratory rate, a blood oxygen saturation, and a blood pressure. As such, since the blood flow of blood vessels of the finger 320 is affected by the heartbeat, the cross-sectional calibre (or diameter) of the blood vessels changes periodically. Moreover, since the illuminating light incident on the blood vessels of the finger 320 will be deflected, as the cross-sectional calibre (or diameter) of the blood vessel changes, the light intensity sensed by the corresponding area of the sensing pixel array 120 will change with the heartbeat. Therefore, the fingerprint sensing device 100 may obtain the corresponding physiological characteristic information through analyzing sensing results of continuous light intensities (continuous images) of a part of the sensing pixels of the sensing pixel array 120.

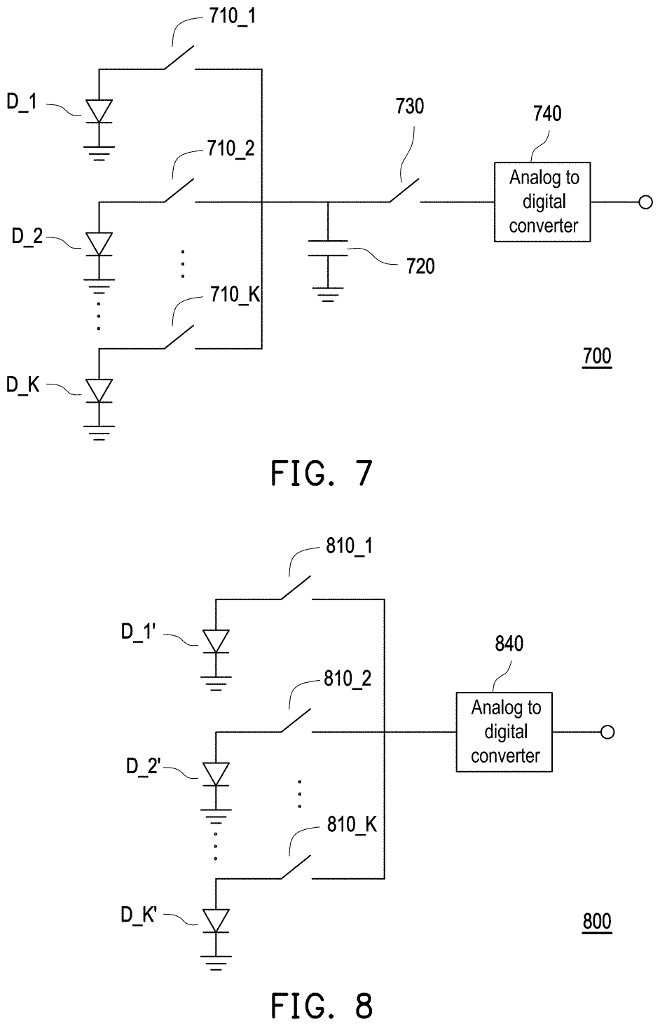

FIG. 7 is a schematic diagram of a sensing circuit according to an embodiment of the disclosure. Referring to FIG. 1 and FIG. 7, the fingerprint sensing device 100 of FIG. 1 may include a sensing circuit 700 architecture as shown in FIG. 7. In the embodiment, multiple sensing units D_1 and D_2 to D_K of the sensing pixels for obtaining the physiological characteristic signal in the sensing pixel array 120 may be respectively coupled to first ends of multiple switching units 710_1 and 710_2 to 710_K, where K is a positive integer. Second ends of the switching units 710_1 and 710_2 to 710_K are coupled to a first end of a storage capacitor 720 and the first end of the switching unit 730. The sensing units D_1 and D_2 to D_K may respectively be photo diodes (PD). A second end of the storage capacitor 720 is grounded. The second end of the switching unit 730 is coupled to an analog to digital converter (ADC) 740. The switching units 710_1, 710_2 to 710_K, and 730 may respectively be switching transistors. In the embodiment, the sensing units D_1 and D_2 to D_K of the respective sensing pixels of the pixel area for obtaining the physiological characteristic signa in the sensing pixel array 120 may be commonly coupled to the storage capacitor 720, that is, the sensing units D_1 and D_2 to D_K may be commonly coupled to the storage capacitor 720 respectively by the switching units 710_1 and 710_2 to 710_K.

During one sampling process, after the sensing units D_1 and D_2 to D_K are exposed, the switching units 710_1 and 710_2 to 710_K may be turned on at the same time, so that the storage capacitor 720 may be configured to store multiple analog sensing signals of the sensing units D_1 and D_2 to D_K of multiple corresponding sensing pixels. Then, when the switching unit 730 is turned on, the analog to digital converter 740 may convert a storage result of the storage capacitor 720 into the ADC code. In other words, the physiological characteristic signal of the embodiment may be a value change result of a voltage signal after analog to digital conversion provided by the storage capacitor 720 of the pixel area for obtaining the physiological characteristic signal in the sensing pixel array 120.

FIG. 8 is a schematic diagram of a sensing circuit according to another embodiment of the disclosure. Referring to FIG. 1 and FIG. 8, the fingerprint sensing device 100 of FIG. 1 may include a sensing circuit 800 architecture as shown in FIG. 8. In the embodiment, multiple sensing units D_1′ and D_2′ to D_K′ of the sensing pixels for obtaining the physiological characteristic signal in the sensing pixel array 120 may be respectively coupled to first ends of multiple switching units 810_1 and 810_2 to 810_K. The sensing units D_1′ and D_2′ to D_K′ may respectively be photo diodes. Second ends of the switching units 810_1 and 810_2 to 810_K are coupled to an analog to digital converter 840. The switching units 810_1 and 810_2 to 810_K may respectively be switching transistors. In the embodiment, the sensing units D_1′ and D_2′ to D_K′ of the respective sensing pixels of the pixel area for obtaining the physiological characteristic signal in the sensing pixel array 120 may be coupled to an input end of the analog to digital converter 840 through the switching units 810_1 and 810_2 to 810_K.

During one sampling process, after the sensing units D_1′ and D_2′ to D_K′ are exposed, the switching units 810_1 and 810_2 to 810_K may be turned on in a time-division manner to output multiple sensing results of the sensing units D_1′ and D_2′ to D_K′ to the analog to digital converter 840 in a time-division manner, so that the analog to digital converter 840 may output multiple ADC codes to a back-end processing circuit, such as the physiological characteristic sensing module 112 shown in FIG. 1. In addition, the back-end processing circuit may add up (accumulate) the ADC codes. In other words, the physiological characteristic signal of the embodiment may be a value change result after adding up the ADC codes output by the sensing pixels of the pixel area for obtaining the physiological characteristic signal in the sensing pixel array 120.

It is supplemented that FIG. 7 and FIG. 8 are only simple architectures of possible implementation examples of the sensing circuit according to some embodiments of the disclosure, and the fingerprint sensing device of the disclosure is not limited thereto. As such, the sensing circuits 700 and 800 of FIG. 7 and FIG. 8 may also include other circuit elements, which are not limited in the disclosure.

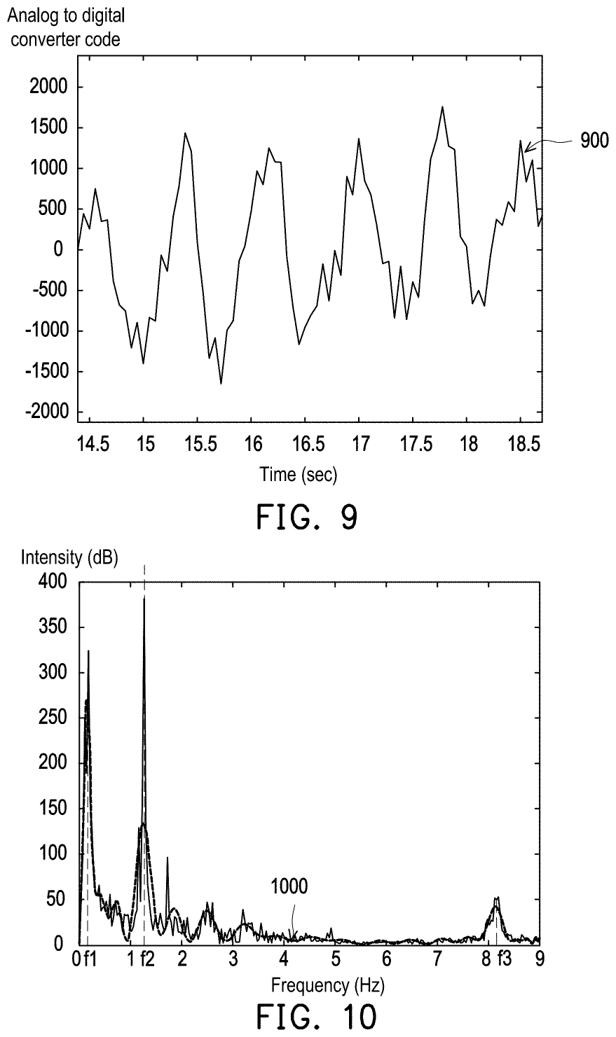

FIG. 9 is a signal waveform diagram of a physiological characteristic signal according to an embodiment of the disclosure. FIG. 10 is a schematic diagram of a frequency domain of a physiological characteristic signal according to an embodiment of the disclosure. Referring to FIG. 1, FIG. 9, and FIG. 10, taking obtaining heartbeat information as an example, the physiological characteristic signal obtained by the sensing pixel array 120 may have a signal waveform 900 as shown in FIG. 9. In addition, if the signal waveform 900 shown in FIG. 9 is converted into a frequency domain, the same may be represented by a frequency domain waveform 1000 shown in FIG. 10. It is worth noting that a frequency f2 with the highest intensity in the frequency domain waveform 1000 may correspond to the heart rate. As such, the frequency f2 may, for example, be 1.266 Hz, and the heart rate may be 1.266×60=75.

In addition, it is worth noting that since the fingerprint sensing device 100 of the embodiment may be implemented as an under-screen optical fingerprint sensing device, a frequency f1 and a frequency f3 corresponding to the second highest intensity in the frequency domain waveform 1000 may be, for example, results of being affected by the flicker effect of a display panel or being interfered by other circuit elements. As such, in an embodiment, in order to reduce or eliminate the influence of the flicker effect of the display panel, the sampling frequency of the sensing pixels of the pixel area for obtaining the physiological characteristic signal in the sensing pixel array 120 may be designed as a multiple of a flicker frequency of the display panel. Alternatively, in another embodiment, the processing circuit 110 may obtain a flicker detection signal through detecting a flicker state of the display panel in real time, and the processing circuit 110 may filter the physiological characteristic signal according to an analysis result of the flicker detection signal in the frequency domain. Therefore, the fingerprint sensing device 100 of the embodiment may obtain highly reliable physiological characteristic information.

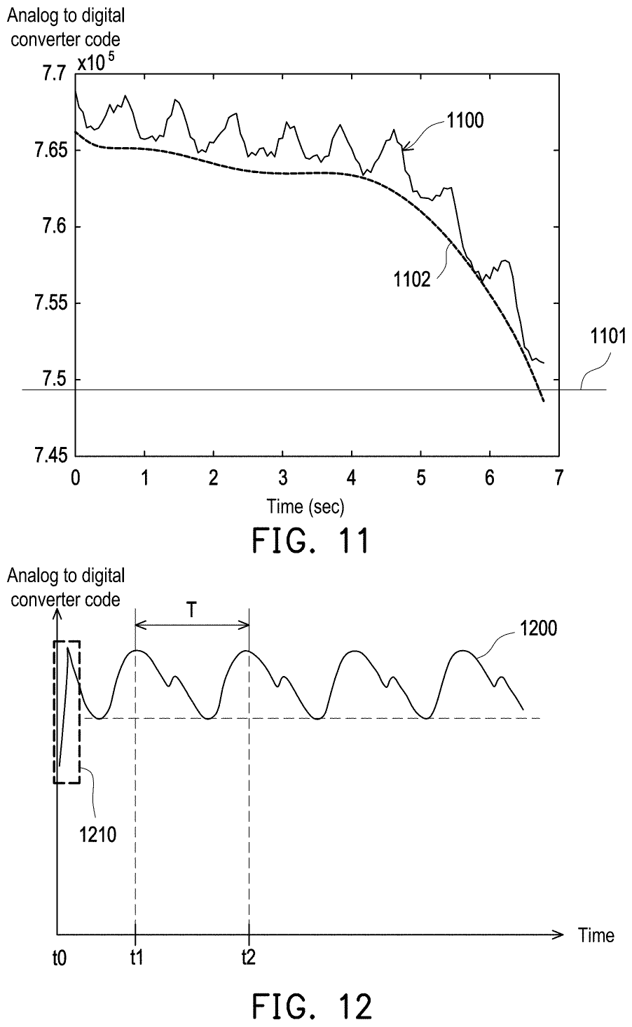

FIG. 11 is a signal waveform diagram of a physiological characteristic signal according to another embodiment of the disclosure. FIG. 12 is a signal waveform diagram of the physiological characteristic signal according to the embodiment of FIG. 11 of the disclosure after correction. Referring to FIG. 1, FIG. 11, and FIG. 12, in the embodiment, when the finger is actually placed or pressing on the fingerprint sensing area of the display panel or a sensing surface of the fingerprint sensing device, since the blood flow dynamically changes with time, by obtaining different amounts of light presented after being reflected, the heartbeat information may be obtained, and actual raw data of the physiological characteristic signal obtained by the sensing pixel array 120 may have a change result of a signal waveform 1100 as shown in FIG. 11. In addition, a pressure change applied by the finger to the fingerprint sensing area may also be observed. For example, a pressing force of the finger decreases during time 4 to 7 seconds (the finger is about to leave).

In addition, according to the explanation of the physiological characteristic signal of FIG. 7 or FIG. 8 described above, since the physiological characteristic signal is the result of adding up the ADC codes of the sensing pixels, the signal waveform 1100 may have a direct current (DC) offset (or a DC level) part 1101 that occupies most of the waveform. As such, the processing circuit 110 may subtract the DC offset part 1101 in the signal waveform 1100 of the physiological characteristic signal, and extract a relatively flat or highly reliable time interval (for example, 0 to 5 seconds) in the signal waveform 1100 to perform, for example, DC offset correction, and a signal waveform 1200 with a relatively flat signal waveform as shown in FIG. 12 may be generated according to the physiological characteristic signal from which the DC offset part 1101 has been subtracted to facilitate the calculation of the heart rate. A waveform change trend 1102 in FIG. 11 may be flattened to facilitate the subsequent judgment and analysis of the heart rate. However, in an embodiment, the processing circuit 110 may also be particularly designed to subtract an analog DC offset part before an analog signal is input to the analog to digital converter, and an effective data volume of the ADC codes output by the analog to digital converter may be increased.

In the embodiment, the processing circuit 110 may analyze whether a signal change of the signal waveform 1200 of the physiological characteristic signal during a first period is a heart rate change to judge whether the finger is a real finger. As such, the first period may be, for example, a time length T greater than a heartbeat cycle from a time t1 to a time t2, and only the processing circuit 110 is required to effectively judge whether a frequency of the signal change is the heart rate change. The processing circuit 110 may, for example, judge whether the frequency of the signal change is between a preset minimum heart rate threshold and a preset maximum heart rate threshold. However, in an embodiment, since a partial waveform 1210 of the signal waveform of the physiological characteristic signal corresponding to the real finger has a particular signal change slope at an initial sensing stage (for example, a short period after a time t0), the processing circuit 110 may also judge whether the finger is a real finger at the initial sensing stage of a fingerprint through analyzing whether the signal change slope of the signal waveform 1200 of the physiological characteristic signal during a waveform initial period is greater than a preset slope, so that whether the finger is a real finger may be judged more quickly.

Referring to FIG. 1 and FIG. 2 again, in some embodiments of the disclosure, the fingerprint sensing device 100 may also use one or more pixel areas of the sensing pixel array 120 corresponding to one or more fingerprint blurred areas or edge areas in the fingerprint image to sense ambient light during a non-fingerprint sensing period to obtain an ambient light sensing signal, and the processing circuit 110 may output ambient sensing information according to the ambient light sensing signal. As such, the sensing information may include at least one of ambient light intensity information and ambient light flicker information. In this way, the brightness of the illuminating light source can be correspondingly adjusted according to the ambient sensing information or the physiological characteristic signal obtained during the fingerprint sensing period can be corrected.

Referring to FIG. 1 and FIG. 2 again, in other embodiments of the disclosure, the sensing pixels of one or more pixel areas of the sensing pixel array 120 corresponding to one or more fingerprint blurred areas or edge areas in the fingerprint image may include multiple color filters (CF), multiple diffraction elements, or multiple surface plasma units for detecting different specific light wavelengths. In this way, the fingerprint sensing device 100 may also use one or more pixel areas of the sensing pixel array 120 corresponding to one or more fingerprint blurred areas or edge areas in the fingerprint image to perform color temperature sensing or XYZ color sensing during another non-fingerprint sensing period.

In summary, the fingerprint sensing device and the operation method thereof of the disclosure can effectively use partial areas of the sensing element array corresponding to the fingerprint blurred areas (fingerprint invalid areas) of the fingerprint image to sense the physiological characteristic information, so that the fingerprint sensing device of the disclosure may obtain the fingerprint image and the physiological characteristic information of the finger at the same time during one fingerprint sensing period. In addition, the sensing result of the physiological characteristic information may also be configured to judge whether the finger is a real finger, so that the fingerprint sensing device may have an anti-counterfeiting function. In addition, the fingerprint sensing device of the disclosure may also use the partial areas of the sensing pixel array to implement the functions of ambient light sensing, color temperature sensing, and/or color sensing.

Although the disclosure has been disclosed in the above embodiments, the embodiments are not intended to limit the disclosure. Persons skilled in the art may make some changes and modifications without departing from the spirit and scope of the disclosure. The protection scope of the disclosure shall be defined by the appended claims.

What is claimed is:

1. A fingerprint sensing device, comprising:
a sensing pixel array, configured to sense a finger during a fingerprint sensing period to obtain a fingerprint sensing signal, wherein at least one pixel area of the sensing pixel array is configured to continuously sense the finger during the fingerprint sensing period to obtain a physiological characteristic signal; and
a processing circuit, coupled to the sensing pixel array and configured to generate a fingerprint image according to the fingerprint sensing signal and generate physiological characteristic information according to the physiological characteristic signal.

2. The fingerprint sensing device according to claim 1, wherein a total area of the at least one pixel area is less than an overall sensing area of the sensing pixel array.

3. The fingerprint sensing device according to claim 1, wherein the at least one pixel area in the sensing pixel array is a position corresponding to at least one image edge area of the fingerprint image.

4. The fingerprint sensing device according to claim 1, wherein the at least one pixel area in the sensing pixel array is an annular area.

5. The fingerprint sensing device according to claim 1, wherein the at least one pixel area of the sensing pixel array is fixedly disposed for obtaining the physiological characteristic signal.

6. The fingerprint sensing device according to claim 1, wherein the processing circuit analyzes the fingerprint image to judge at least one blurred area in the fingerprint image, and the processing circuit decides to set a part in the sensing pixel array corresponding to the at least one blurred area as the at least one pixel area.

7. The fingerprint sensing device according to claim 6, wherein the processing circuit judges that there is the at least one blurred area in the fingerprint image where a fingerprint signal intensity is lower than a signal intensity threshold to decide to set the part in the sensing pixel array corresponding to the at least one blurred area as the at least one pixel area.

8. The fingerprint sensing device according to claim 6, wherein the processing circuit judges that there is the at least one blurred area in the fingerprint image where a fingerprint characteristic is less than a characteristic number threshold to decide to set the part in the sensing pixel array corresponding to the at least one blurred area as the at least one pixel area.

9. The fingerprint sensing device according to claim 1, wherein a plurality of respective sensing pixels of the at least one pixel area of the sensing pixel array are commonly coupled to a storage capacitor, and the storage capacitor is configured to store a plurality of analog sensing signals of the corresponding sensing pixels, wherein the physiological characteristic signal is a value change result of a voltage signal after analog to digital conversion provided by the respective storage capacitor of the at least one pixel area.

10. The fingerprint sensing device according to claim 1, wherein the physiological characteristic signal is a value change result after adding up a plurality of analog to digital converter codes output by a plurality of sensing pixels of the at least one pixel area.

11. The fingerprint sensing device according to claim 1, wherein a sampling frequency of a plurality of sensing pixels of the at least one pixel area of the sensing pixel array is between 4 Hz and 1 kHz.

12. The fingerprint sensing device according to claim 1, wherein a sampling frequency of a plurality of sensing pixels of the at least one pixel area of the sensing pixel array is a multiple of a flicker frequency of a display panel.

13. The fingerprint sensing device according to claim 1, wherein the processing circuit detects a flicker state of a display panel to obtain a flicker detection signal, and filters the physiological characteristic signal according to an analysis result of the flicker detection signal in a frequency domain.

14. The fingerprint sensing device according to claim 1, wherein the processing circuit subtracts a direct current (DC) offset part of the physiological characteristic signal to generate the physiological characteristic information according to the physiological characteristic signal from which the DC offset part has been subtracted.

15. The fingerprint sensing device according to claim 1, wherein the processing circuit analyzes whether a signal change slope of the physiological characteristic signal during a waveform initial period is greater than a preset slope to judge whether the finger is a real finger.

16. The fingerprint sensing device according to claim 1, wherein the processing circuit analyzes whether a signal change of the physiological characteristic signal during a first period is a heart rate change to judge whether the finger is a real finger.

17. The fingerprint sensing device according to claim 1, wherein the fingerprint sensing device is an optical fingerprint sensor.

18. The fingerprint sensing device according to claim 1, wherein the sensing pixel array comprises at least one lens or collimator.

19. The fingerprint sensing device according to claim 1, wherein during the fingerprint sensing period, the finger is illuminated by a light source, and the light source is an organic light-emitting diode display panel.

20. The fingerprint sensing device according to claim 1, wherein the physiological characteristic information comprises at least one of a heart rate, a respiratory rate, a blood oxygen saturation, and a blood pressure.

21. The fingerprint sensing device according to claim 1, wherein the at least one pixel area of the sensing pixel array is further configured to sense an ambient light during a first non-fingerprint sensing period to obtain an ambient light sensing signal, and the processing circuit outputs ambient sensing information according to the ambient light sensing signal.

22. The fingerprint sensing device according to claim 21, wherein the ambient sensing information comprises at least one of ambient light intensity information and ambient light flicker information.

23. The fingerprint sensing device according to claim 1, wherein a plurality of sensing pixels of the at least one pixel area of the sensing pixel array comprises a plurality of color filters, a plurality of diffraction elements, or a plurality of surface plasma units for detecting different specific light wavelengths.

24. The fingerprint sensing device according to claim 23, wherein the at least one pixel area of the sensing pixel array is further configured to perform color temperature sensing during a second non-fingerprint sensing period.

25. The fingerprint sensing device according to claim 23, wherein the at least one pixel area of the sensing pixel array is further configured to perform XYZ color sensing during a third non-fingerprint sensing period.

26. The fingerprint sensing device according to claim 1, wherein the fingerprint sensing device is a single chip.

27. An operation method of a fingerprint sensing device, comprising:
sensing a finger through a sensing pixel array during a fingerprint sensing period to obtain a fingerprint sensing signal;
generating a fingerprint image according to the fingerprint sensing signal;
continuously sensing the finger through at least one pixel area of the sensing pixel array during the fingerprint sensing period to obtain a physiological characteristic signal; and
generating physiological characteristic information according to the physiological characteristic signal.

28. The operation method according to claim 27, wherein a total area of the at least one pixel area is less than an overall sensing area of the sensing pixel array.

29. The operation method according to claim 27, wherein the at least one pixel area in the sensing pixel array is a position corresponding to at least one image edge area of the fingerprint image.

30. The operation method according to claim 27, wherein the at least one pixel area in the sensing pixel array is an annular area.

31. The operation method according to claim 27, wherein the at least one pixel area of the sensing pixel array is fixedly disposed for obtaining the physiological characteristic signal.

32. The operation method according to claim 27, further comprising:
analyzing the fingerprint image to judge at least one blurred area in the fingerprint image, and decide to set a part in the sensing pixel array corresponding to the at least one blurred area as the at least one pixel area.

33. The operation method according to claim 32, wherein the step of deciding the at least one pixel area comprises:
judging that there is the at least one blurred area in the fingerprint image where a fingerprint signal intensity is lower than a signal intensity threshold to decide to set the part in the sensing pixel array corresponding to the at least one blurred area as the at least one pixel area.

34. The operation method according to claim 32, wherein the step of deciding the at least one pixel area comprises:
judging that there is the at least one blurred area in the fingerprint image where a fingerprint characteristic is less than a characteristic number threshold to decide to set the part in the sensing pixel array corresponding to the at least one blurred area as the at least one pixel area.

35. The operation method according to claim 27, wherein a sampling frequency of a plurality of sensing pixels of the at least one pixel area of the sensing pixel array is between 4 Hz and 1 kHz.

36. The operation method according to claim 27, wherein a sampling frequency of a plurality of sensing pixels of the at least one pixel area of the sensing pixel array is a multiple of a flicker frequency of a display panel.

37. The operation method according to claim 27, further comprising:
detecting a flicker state of a display panel to obtain a flicker detection signal; and
filtering the physiological characteristic signal according to an analysis result of the flicker detection signal in a frequency domain.

38. The operation method according to claim 27, wherein the step of generating the physiological characteristic information according to the physiological characteristic signal comprises:
subtracting a DC offset part of the physiological characteristic signal to generate the physiological characteristic information according to the physiological characteristic signal from which the DC offset part has been subtracted.

39. The operation method according to claim 27, further comprising:
analyzing whether a signal change slope of the physiological characteristic signal during a waveform initial period is greater than a preset slope to judge whether the finger is a real finger.

40. The operation method according to claim 27, further comprising:
analyzing whether a signal change of the physiological characteristic signal during a first period is a heart rate change to judge whether the finger is a real finger.

41. The operation method according to claim 27, wherein the physiological characteristic information comprises at least one of a heart rate, a respiratory rate, a blood oxygen saturation, and a blood pressure.

42. The operation method according to claim 27, further comprising:
sensing an ambient light through the at least one pixel area of the sensing pixel array during a first non-fingerprint sensing period to obtain an ambient light sensing signal; and
outputting sensing information according to the ambient light sensing signal.

43. The operation method according to claim 42, wherein the sensing information comprises at least one of ambient light intensity information and ambient light flicker information.

44. The operation method according to claim 27, further comprising:
performing color temperature sensing through the at least one pixel area of the sensing pixel array during a second non-fingerprint sensing period.

45. The operation method according to claim 27, further comprising:
performing XYZ color sensing through the at least one pixel area of the sensing pixel array during a third non-fingerprint sensing period.
